(19) United States
(12) Patent Application Publication
(10) Pub. No.: US 2011/0078718 A1
(43) Pub. Date: Mar. 31, 2011

(54) TARGETING VIDEOS FOR ADVERTISEMENTS BY AUDIENCE OR CONTENT

(75) Inventors: Nicholas Jakobi, Zurich (CH); Thomas Rikert, San Francisco, CA (US); Shishir Mehrotra, Palo Alto, CA (US); Aaron Lee, San Francisco, CA (US); Emmett Cunningham, Brisbane, CA (US); Ikkjin Ahn, Deagu (KR); Beth Ellyn McClendon, Portola Valley, CA (US); Thierry Le Boulengé, Zurich (CH); Andras Nemeth, Zurich (CH); Tamas Foldenyi, Zurich (CH); Steven Dropsho, Zurich (CH); Reto Strobl, Walenstadt (CH); Michael Hatscher, Zurich (CH)

(73) Assignee: Google Inc., Mountain View, CA (US)

(21) Appl. No.: 12/569,342

(22) Filed: Sep. 29, 2009

(51) Int. Cl. H04N 7/025; H04H 60/32; H04N 7/10

(52) U.S. Cl. 725/14; 725/34; 725/35

(57) ABSTRACT

A video hosting service stores and provides video content to a client via a network. Advertisers search for videos to target by entering search criteria into a user interface. Advertisers can search based on characteristics of the audience (viewers) of the videos, such as age range, gender, and interests of the viewers, and/or based on metadata associated with the videos. A set of videos that meet the search criteria is then retrieved. Advertisers can select individual ones of these videos or groups of these videos. The selected videos or groups of videos can be added to a media plan. The items from the media plan can be imported into an advertising campaign management system, wherein the advertiser's ads are associated with the selected videos. Subsequently, viewers who view the selected videos also view the advertiser's ads in connection with the videos.

### BACKGROUND

1. Field of the Invention

This invention generally relates to targeting videos on a video web site for placements of advertisements and more specifically to targeting videos by audience or content.

2. Description of the Related Art

The sharing of video content on websites has developed into a worldwide phenomenon. On average, over 10,000 videos are posted to video sharing websites every day, and this number is increasing as the tools and opportunities for capturing video become easy to use and more widespread. Shared video content provides opportunities to present advertising to viewers along with the requested video content. Oftentimes, there is a desire to target the advertising to particular types of viewers and content.

One technique for delivering targeted advertising is for an advertiser to associate an advertisement with particular terms in a search query and/or generally with the set of search results that result from the query. For example, a targeted advertisement can be presented if a particular term appears in a search query. Advertisers can bid for particular terms that are likely to appear in search queries and have their advertisements presented when the terms appear in the query or as keywords (e.g., tags) associated with the videos in the results set.

### SUMMARY

Embodiments of the invention include methods, computer-readable storage media, and computer systems for targeting videos based on the audience characteristics or the actual content of the video. Advertisers search for videos by entering search criteria into a user interface. Advertisers can search based on characteristics of the audience (viewers) of the videos, such as age range, gender, and interests of the viewers, and/or based on metadata associated with the videos. A set of videos that meet the search criteria is then retrieved. Through a graphical user interface, advertisers can select individual ones of these videos or groups of these videos. The selected videos or groups of videos can be added to a media plan associated with the advertiser. The items from the media plan can be imported into an advertising campaign management system, wherein the advertiser's ads are associated with the selected videos or groups of videos. Subsequently, viewers who view videos from among the selected videos and groups of videos also view the advertiser's ads in connection with the videos, for example as instream advertisements or as overlays on the videos.

### BRIEF DESCRIPTION OF THE DRAWINGS

FIG. 1 is a high-level block diagram of a computing environment according to one embodiment.

FIG. 2 is a high-level block diagram illustrating an example of a computer for use as a video hosting service, an advertising campaign management system, and/or client.

FIG. 3A is a block diagram illustrating elements of the video hosting service according to one embodiment.

FIG. 3B is a block diagram illustrating modules of the video targeting tool of the video hosting service, according to one embodiment.

FIG. 4 is a sequence diagram illustrating the steps involved in selecting videos or groups of videos for placing targeted advertisements according to one embodiment.

FIG. 5 illustrates a user interface for targeting videos by audience or content according to an embodiment.

FIG. 6 illustrates a user interface for selecting individual videos meeting the selected criteria according to an embodiment.

FIG. 7 illustrates a user interface for selecting individual videos from among a wall of videos meeting the selected criteria according to one embodiment.

FIG. 8 illustrates the user interface for selecting channels of videos meeting the selected criteria according to an embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION

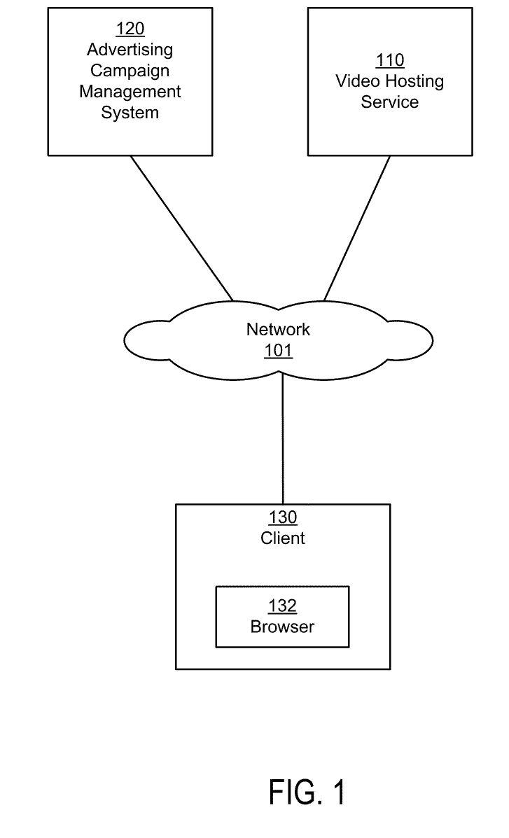

FIG. 1 is a high-level block diagram of a computing environment 100 according to one embodiment. FIG. 1 illustrates a video hosting service 110, an advertising campaign management system 120, and a client 130 connected by a network 101. Only one client 130 is shown in FIG. 1 in order to simplify and clarify the description. In practices, the computing environment 100 can have thousands or millions of clients 130, as well as multiple video hosting services 110 and advertising campaign management systems 120. Some clients 130 will be used by viewers and other clients 130 will be used by advertisers in the manner described below.

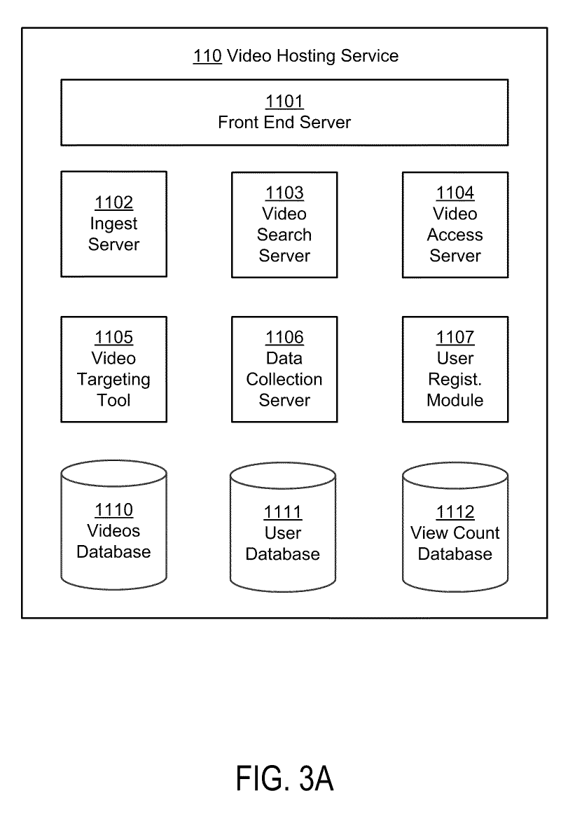

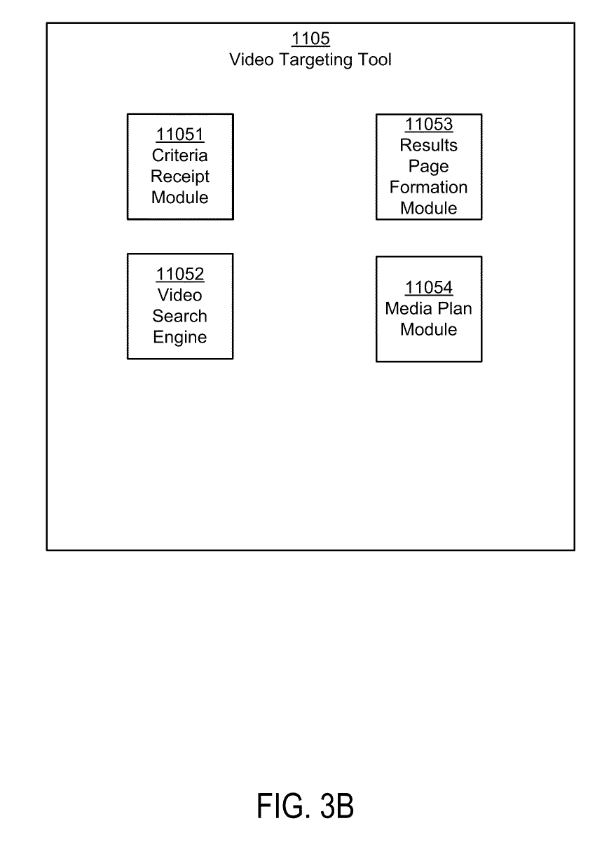

The video hosting service 110 provides video content (referred to herein as “videos”) to the client 130 via the network 101. In one embodiment, the video hosting service 110 is located at a website provided by YOUTUBE, LLC of San Bruno, Calif., although the video hosting service 110 can also be provided by another entity. As will be described below in more detail with respect to FIGS. 3A-3B, the video hosting service 110 includes databases for storing multiple videos, the descriptions of the content of each video, user demographic data, and data for tracking the views of the videos. The video hosting service 110 also includes a video targeting tool 1105 that advertisers use to select specific videos or groups of videos with which to show the advertiser's ads.

The advertising campaign management system 120 manages and stores advertising content, and provides the advertising content (i.e., ads) to clients 130 via the network 101 in association with videos from the video hosting service 110. In some instances, the advertising content is in the same format as the content provided by the video hosting service 110 (e.g., is a playable video ad). In other instances, other types of advertising are provided to the clients, such as pure text advertising, advertising providing a hyperlink to an advertiser's website, text-and-audio advertising, and static image advertising. In one embodiment, the functions of the advertising campaign management system 120 are provided by the video hosting service 110, rather than by a separate system.

The ads managed by the advertising campaign management system 120 are supplied by an advertiser who selects the specific videos or groups of videos with which to show the ad, using the video targeting tool 1105 of the video hosting service 110 described herein. The advertiser may submit bids for the specified videos, agree to pay rates specified by a rate card, or agree to other payment terms associated with the video or group of videos.

The client 130 is a computer or other electronic device used by one or more users to perform activities including viewing video content received from the video hosting service 110 and viewing advertising received from the advertising campaign management system 120. The client 130, for example, can be a personal computer executing a web browser 132 that allows the user to browse and search for videos available from the video hosting service 110. In other embodiments, the client 130 is a network-capable device other than a computer, such as a personal digital assistant (PDA), a mobile telephone, a pager, a television “set-top box,” etc. Whereas some users use clients 130 to access the video hosting service 110 primarily to view videos, advertisers also use clients 130 to access the video hosting service 110 to select videos in connection with which to show advertising, as will be described in detail below.

The network 101 represents the communication pathways between the video hosting service 110, the advertising campaign management system 120, and the client 130. In one embodiment, the network 101 is the Internet. The network 101 can also utilize dedicated or private communications links that are not necessarily part of the Internet. In one embodiment, the network 101 uses standard communications technologies and/or protocols. Thus, the network 101 can include links using technologies such as Ethernet, 802.11, integrated services digital network (ISDN), digital subscriber line (DSL), asynchronous transfer mode (ATM), etc. Similarly, the networking protocols used on the network 101 can include the transmission control protocol/Internet protocol (TCP/IP), the hypertext transport protocol (HTTP), the simple mail transfer protocol (SMTP), the file transfer protocol (FTP), etc. The data exchanged over the network 101 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

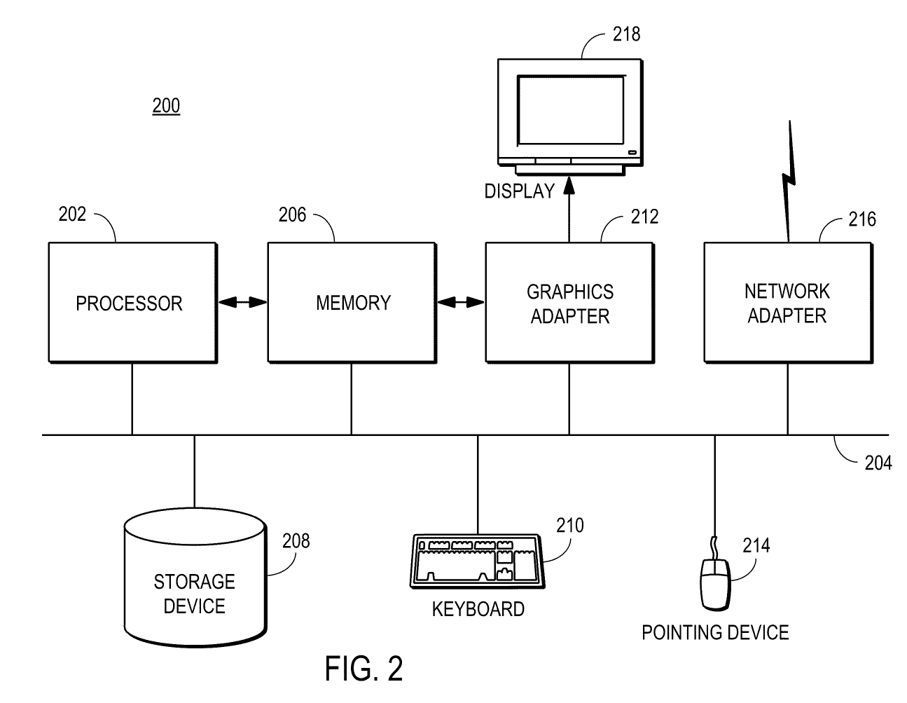

FIG. 2 is a high-level block diagram illustrating an example of a computer 200 for use as a server computer in the video hosting service 110, an advertising campaign management system 120, and/or client 130. Illustrated are a processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212.

The processor 202 may be any general-purpose processor. The storage device 208 is, in one embodiment, a hard disk drive but can also be any other device capable of storing data, such as a writeable compact disk (CD) or DVD, or a solid-state memory device. The memory 206 may be, for example, firmware, read-only memory (ROM), non-volatile random access memory (NVRAM), and/or RAM, and holds instructions and data used by the processor 202. The pointing device 214 may be a mouse, track ball, or other type of pointing device, and is used in combination with the keyboard 210 to input data into the computer 200. The graphics adapter 212 displays images and other information on the display 218. The network adapter 216 couples the computer 200 to the network 101.

As is known in the art, the computer 200 is adapted to execute computer program modules. As used herein, the term “module” refers to computer program logic and/or data for providing the specified functionality. A module can be implemented in hardware, firmware, and/or software. In one embodiment, the modules are stored on the storage device 208, loaded into the memory 206, and executed by the processor 202. The computer 200 is configured to perform the specific functions and operations by various modules, for example as detailed in FIGS. 3A-3B, and thereby operates as a particular computer under such program control.

The types of computers 200 utilized by the entities of FIG. 1 can vary depending upon the embodiment and the processing power utilized by the entity. For example, a client 130 that is a mobile telephone typically has limited processing power, a small display 218, and might lack a pointing device 214. A server in the video hosting service 110, in contrast, may comprise multiple blade servers working together to provide the functionality described herein.

FIG. 3A is a high-level block diagram illustrating elements of the video hosting service 110 according to one embodiment. Some embodiments of the video hosting service 110 have different and/or other modules than the ones described here. Similarly, the functions can be distributed among the elements in accordance with other embodiments in a different manner than is described here. Depending upon the embodiment, certain modules can be incorporated into other modules of the video hosting service 110 and/or other entities on the network 101, including the client 130. Regardless of the particular arrangement, in all instances the video hosting service 110 is specifically configured by the modules it is executing and thereby operates as a particular computer system.

As shown in FIG. 3A, the video hosting service 110 includes a front end server 1101, an ingest server 1102, a video search server 1103, a video access server 1104, a video targeting tool 1105, a data collection server 1106, and a user registration module 1107. The video hosting service 110 also includes a videos database 1110, a user database 1111, and a view count database 1112.

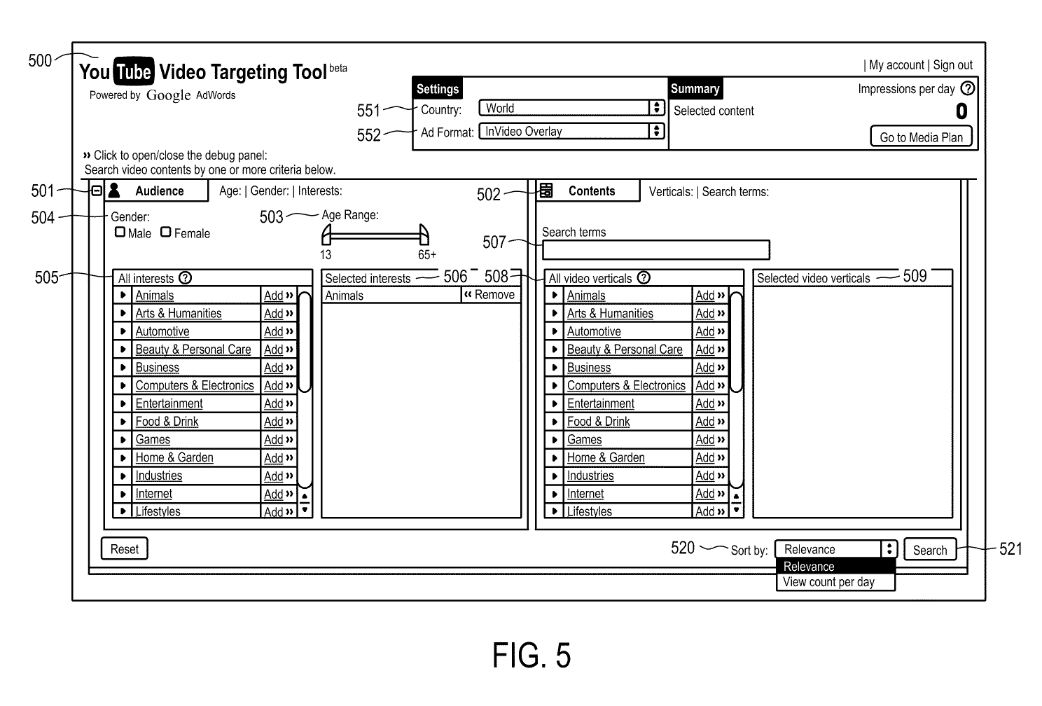

The front end server 1101 handles communication with the clients 130 via the network 101. The front end server provides a user interface in a web page to the client 130, and interactions with clients 130 are handled through the user interface. For example, a user may select videos to view through the webpage provided to user's client 130. As another example, an advertiser receives a separate webpage at its client 130 to select videos in connection with which to show targeted advertising. Examples of the user interface web pages for targeting videos by audience characteristics and content are shown in FIGS. 5-10. The front end server 1101 receives requests from the clients 130 and communicates with the other servers of the video hosting service 110 to process the requests.

The ingest server 1102 processes video files received by the front end server 1101 from a user for posting to the video hosting service 110. In one embodiment, the processing of a video file received includes assigning a video identification (video ID) to the video file and storing the video file in a videos database 1110. Other steps that may be involved in the processing of the received video file before storing it in the videos database 1110 include: formatting (e.g., transcoding), compressing, metadata tagging, content analysis, and/or other data processing methods. In one embodiment, the front end server 1101 also receives a form with the video file received from the user. The form includes information entered by the user about the video, such as the title, description, and tag information. The ingest server 1102 stores the information included in the form as metadata of the video file in the videos database 1110. Additionally, the ingest server 1102 updates data contained on the user that transmitted the video file to the video hosting service 110 in the user database 1111. In one embodiment, the ingest server 1102 stores the video ID assigned to the stored video file with the data of the respective user in the user database 1111.

In one embodiment, the videos database 1110 is a storage system that includes video files shared by the video hosting service 110 with users. All of the videos contributed by one entity are referred to as a single “channel.” The videos stored in the videos database 1110 may also be organized into vertical hierarchical categories according to content, referred to herein as “verticals,” with categories higher in the hierarchy being more general than categories lower in the hierarchy. For example, a category for a hip-hop music artist might belong to the category “entertainment|music|urban|artist.” Here, “entertainment” is the top category, “music” is a sub-category of entertainment, “urban” is a sub-category of music, and “artist” (i.e., the name of the artist) is a sub-category of urban.

The user database 1111 includes data on users that communicate with the video hosting service 110. An example of data included in the user database 1111 for a specific user includes the video IDs of video files transmitted by the user to the video hosting service 110 and the video IDs of video files that the user has accessed from the videos database 1110 for viewing. Additionally, the user database 1111 also stores demographic information about the user, including the user's gender, age, subject matter interests, income level, where the user lives (e.g., country, state, etc.), and/or any other demographic information.

The user registration module 1107 creates and manages user accounts for the video hosting service 110, although in some implementations it is not necessary to have an account to view videos from the video hosting service 110. For those users who establish accounts, during account creation, users are requested to provide demographic information and a user login is assigned. The user registration module 1107 stores the user demographic information in the user database 1111 associated with the respective login. For users who do not establish accounts, they may be identified by the user's internet protocol address, which the user registration module 1107 can store in the user database 1111.

The video search server 1103 processes any search queries received by the front end server 1101 from users seeking to view videos. A search query received by the front end server 1101 from a user includes search criteria, such as keywords that may identify videos the user is interested in viewing. The video search server 1103 uses the search criteria to query the metadata of video files stored in the videos database 1110. The search results from the query are transmitted to the front end server 1101 for presentation to the user. For example, if a user provides the front end server 1101 with a keyword search query with the word “Lakers” the video search server 1103 identifies videos stored in the videos database 1110 related to the word “Lakers.”

The video access server 1104 processes requests from users (“viewers”) to access certain videos. In one embodiment, the video access server 1104 receives a request from a viewer to access a video when the viewer clicks on a link to the video. The request received from the viewer includes the video ID of the video the viewer wishes to access for viewing (this can be included automatically once the viewer clicks on the link for the video). The video access server 1104 uses the video ID to search and locate the video in the videos database 1110. Once the requested video is located, the video access server 1104 transmits the video to the viewer via the front end server 1101. The video is presented to the viewer on a web page. Metadata associated with the video may also be presented with the video, such as the title and description of the video. In one embodiment, after transmitting the video to the viewer, the video access server 1104 stores the video ID of the video transmitted to the viewer in the user database 1111 with the data of the respective viewer. In another embodiment, the video access server 1104 responds to requests from advertisers to preview videos being considered for placements of advertisements.

The data collection server 1106 collects data on the demographic profile of the users who watch each video, and stores the information in the view count database 1112 according to the demographics. The view count can be tallied as a whole for the viewers of a video and tallied separately along each demographic division, such as gender, age, region of the world, etc., if such information is available, for example, if such information has been provided by users. The view counts are updated each time a viewer accesses a video. For example, assume User A requests and watches a video B. The video access server 1104 notifies the data collection server 1106 that User A has viewed video B. The data collection server 1106 pulls the demographic information about User A from the user database 1111, which in this example contains the information that User A is an 18-year-old male. The data collection server 1106 updates the view count database 1112 to reflect that an 18-year-old male has viewed video B. Thus, the total view count for video B is incremented by 1, as is the view count for males who viewed video B and the view count for 18-year-olds who viewed video B. Likewise, the tallies along any other demographic partitioning can be updated in the view count database 1112 according to the information pulled from the user database 1111 by the data collection server 1106. For example, view counts can be recorded according to a number of different granularities for age ranges and/or recorded according to keywords that are used in users' profiles. If no demographic information about User A is available from the user database 1111 (perhaps because User A has not established an account through the user registration module 1107), the total view count for video B is still incremented by 1, but the demographic tallies are not altered. The information in the view count database 1112 is used to calculate the number of views per day of each video, which determines the number of impressions per day that an advertiser can expect from placing an ad in connection with the video. The information in the view count database 1112 is also used to identify which videos have audiences that skew towards or match demographic characteristics that an advertiser desires for the audience of the advertiser's ads. The score of a video with respect to a given audience is computed as follows: Let m be the watches of a video by the target audience; M be the total watches of the video; N be the total watches of the target audience on any video; w be the weight (between 0 and 1 inclusive) given to recall; and then the score of a video is

$$\frac{m}{( {N}^{w} {M}^{( 1 - w )} )} .$$

The video targeting tool 1105 of the video hosting server 110 will now be described with reference to FIG. 3B. The video targeting tool includes a criteria receipt module 11051, a video search engine 11052, a results page formation module 11053, and a media plan module 11054.

In one embodiment, the front end server 1101 of the video hosting server 110 provides a web page containing a user interface that allows an advertiser to input video search criteria. An advertiser uses the browser 132 of a client 130 to enter the search criteria and submit it to the front end server 1101 that passes the criteria to the criteria receipt module 11051. The search criteria include one or more characteristics of the viewers of the video or criteria relevant to the content of the video. The criteria receipt module 11051 extracts the search criteria from the advertiser's input. In one embodiment, the advertiser's input is in the form of a search query, and the criteria receipt module 11501 receives the search query and parses it by performing tasks including verifying the query syntax, filtering out stop words, identifying the query terms, and identifying any query parameters. The criteria receipt module 11501 then provides the search criteria to the other modules of the video targeting tool 1105.

A video search engine 11502 of the video targeting tool 1105 processes the criteria received from the advertiser via the criteria receipt module 11051. The video search engine 11052 uses the criteria to query the videos database 1110 to find videos that satisfy the input criteria.

A results page formation module 11053 forms a results page containing search results generated in response to the video search engine 11052 querying the videos database 1110. The results page formation module 11053 forms a results page that lists the video results, and may also list associated information like suggested alternative queries and options for ranking the results. The results page formation module 11053 may include one or more thumbnail images from the videos in the result set, and may include information such as the title of the video, a description of the video, a rating of the video, the date the video was contributed, the total number of view of the video and the number of view per day, the length of the video, and/or any other descriptive information related to the video that has been stored as metadata in the videos database 1110. The results page formation module 11053 passes the results page to the front end server 1101 to provide to the client 130. The advertiser can select videos of interest for placing ads from the results page.

The media plan module 11054 manages the selected videos and groups of videos for which the advertiser has expressed an interest in placing ads. The media plan module 11054 displays the advertiser's selections, for example in a list, and the user can add or delete items from the list. In one embodiment, the items from the media plan can be imported into an advertising campaign management system 114, such as GOOGLE ADWORDS™ wherein the advertiser's ads are associated with the selected videos or groups of videos. Subsequently, viewers who view videos from among the selected videos and groups of videos from the video hosting service 110 also view the advertiser's ads in connection with the videos.

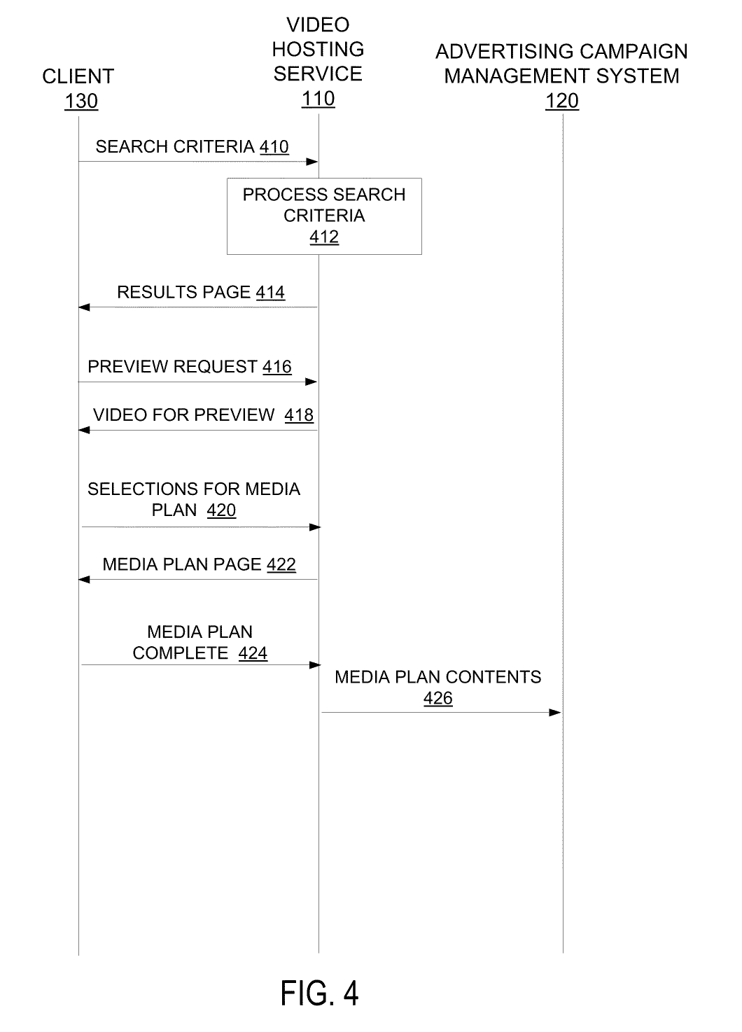

FIG. 4 is a sequence diagram illustrating the steps involved in selecting videos or groups of videos for placing targeted advertisements according to one embodiment. In the diagram, the three vertical lines respectively represent the client 130, a video hosting server 110, and an advertising campaign management system 120. Time flows from the top to the bottom of the figure and the horizontal lines between the entities represent communications. Boxes on the lines represent activities performed by the associated entity. Other embodiments can perform the steps of FIG. 4 in different orders. Moreover, other embodiments can include different and/or additional steps and communications than the ones described here. In some embodiments, the functions of the video hosting service 110 and the advertising campaign management system 120 are provided by one combined system. Alternatively, the video hosting service 110 and the advertising campaign management system 120 are operated by the same entity in some embodiments.

The steps illustrated in FIG. 4 will be described with reference to the user interfaces shown in FIGS. 5-8. An advertiser uses the client 130 to browse a web site provided by the video hosting service 110 to search for videos in order to target advertisements at viewers of those videos.

The client 130 receives search criteria from the advertiser, which the client 130 then provides 410 to the criteria receipt module 11051 of the video targeting tool 1105 of the video hosting service 110. The search criteria may include characteristics of the audience of the video and/or criteria relevant to the content of the video. FIG. 5 illustrates a user interface 500 for targeting videos by audience or content according to an embodiment. In this example, the user interface 500 includes an audience tab 501 and a contents tab 502 that are used to access the user interface elements for inputting the targeting criteria. The advertiser can choose to select one or both of these tabs 501, 502 according to how the advertiser desires to select videos, either by audience characteristics of the videos, by the contents of the video, or both. Within the audience tab 501, the advertiser can select the gender of the audience using the gender selector 504; the age range of the audience using the age range selector 503 for adjusting the upper and lower boundaries on the desired age of the audience using a slider or other input mechanism (e.g., fields for minimum and maximum age); and the interests of the audience from the list of all interests 505. Once one or more interests have been selected from the list of all interests 505, they appear in the selected interests list 506. Within the contents tab 502, the advertiser can enter search terms into the search term entry box 507, and/or drill down through the list of all video verticals 508 that are displayed in hierarchical fashion to find desired content. Once video verticals have been selected from the list of all video verticals 508, they appear in the selected video verticals list 509. Additionally, the advertiser may optionally specify additional criteria, such as country from menu 551 and/or videos that accept a particular ad format from menu 552. Options for the ad format menu 851 may include overlay, instream video, and both overlays and instream videos. In this example, the advertiser can also select how to sort search results using the drop down menu 520, for example by relevance to the search criteria or by view count per day. When the advertiser's selections of criteria are complete, the advertiser can select the search button 521. The advertiser's selections of criteria are used to drive a search by the video search engine 11052 of the video targeting tool 1105 for videos that meet the selected criteria.

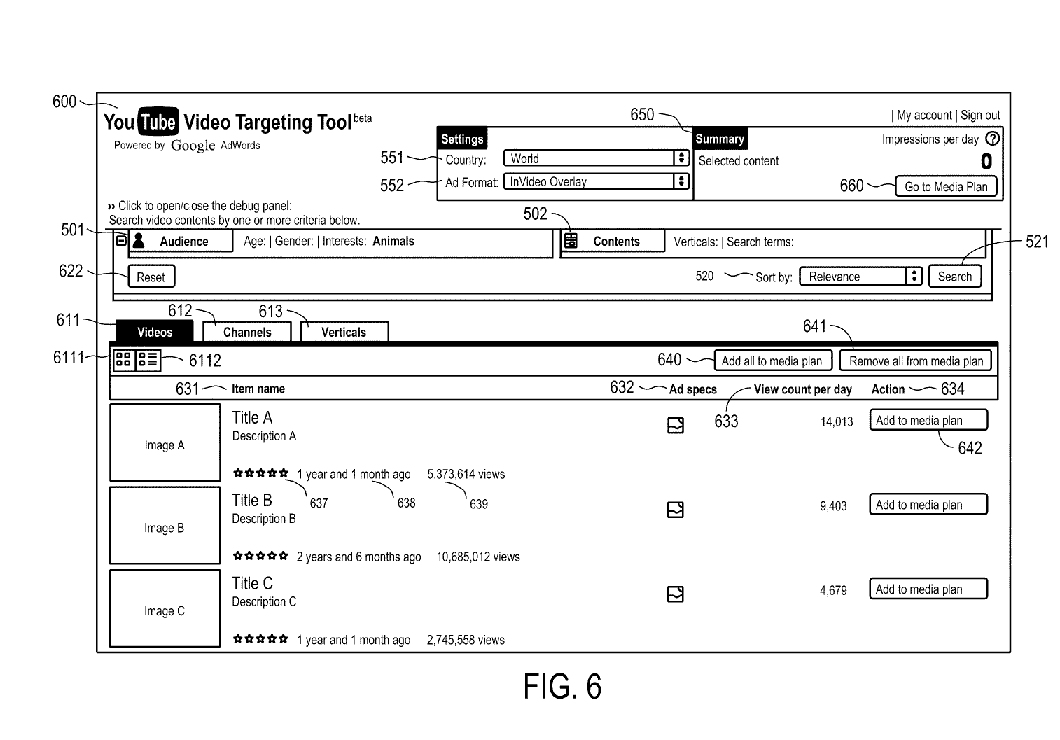

Referring back to FIG. 4, the video hosting service 110 processes 412 the search criteria in order to form a results page listing videos or groups of videos that meet the search criteria. The video hosting service 110 returns 414 the results page to the client 130. The browser 132 at the client 130 receives and displays the results page. FIGS. 6-8 illustrates example results pages, which provide user interfaces for selecting individual videos meeting the selected audience characteristics, according to an embodiment. A video is considered to meet the selected audience characteristics if it is in the top N videos ordered by audience score computed as described above. N is typically 200, although N may be set higher or lower by default or by user preference in various embodiments.

In the example of FIG. 6, the advertiser has selected to search for videos that meet the criteria of having the audience interested in animals. To clear the criteria, the advertiser can select the reset button 622 and make new criteria selections from the user interface 500 shown in FIG. 5. In the example shown in FIG. 6, the advertiser has several options for how to view the results from the advertiser's search for videos that meet the audience criteria. These options are represented by the videos tab 611, the channels tab 612, and the verticals tab 613.

In FIG. 6, the user interface 600 displays the contents of the videos tab 611 as a list of videos including the item name 631, the ad specifications 632, and the view count per day 633. Under the item name 631, each item may include a thumbnail from the video, and the title of the video can be displayed along with a description of the video, a rating 637 of the video, an indication of when the video was contributed 638, and a total number of views of the video 639. In some embodiments, the ad specifications 632 column includes a list of the acceptable ad formats that can be used in connection with the video, for example, playable video ads, text overlays on portions of the video, static images, etc. The view count per day column 633 contains the number of times the video is played (in whole or part) per day. The advertiser has the option to select videos individually by selecting the add to media plan button 642 under the action column 634 or to add all the videos to the media plan by selecting the add all to media plan button 640. Likewise, the advertiser can remove all items from the media plan by selecting the remove all from media plan button 641. To access the advertiser's media plan, including a list of all items added to the media plan, the advertiser can select the go to media plan button 660. For convenience, a summary 650 of the selected content, including the total estimated view count per day over all of the advertiser's selected items for the media plan is presented as part of the user interface 600.

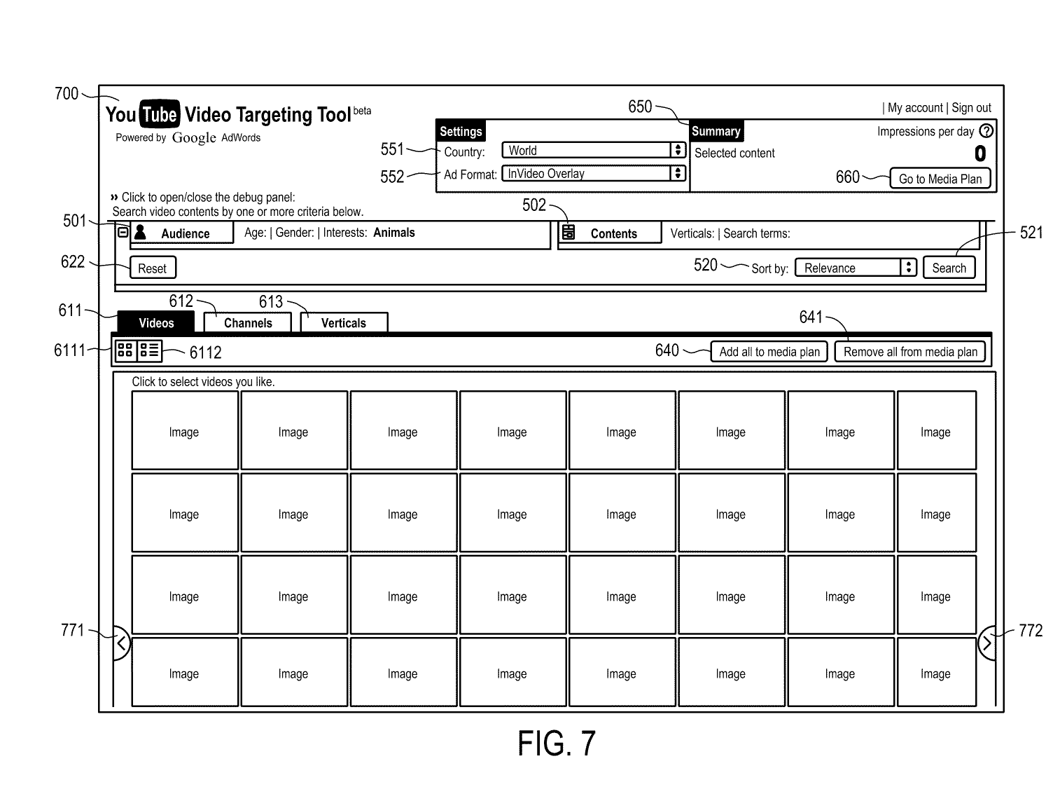

From the user interface 600, the advertiser has an option of displaying the items that meet the advertiser's criteria in a list view or as a wall of videos. The user interface 600 displaying the list view corresponds to button 6112. FIG. 7 illustrates a user interface 700 for displaying the videos that meet the advertiser's criteria as a wall of videos, which corresponds to button 6111. The wall of videos may comprise a grid of images, wherein each image in the grid is an image from a different video from the results set. The advertiser can navigate through the thumbnail images by selecting the left 771 or right 772 navigation buttons. The advertiser can select individual videos, for example by double-clicking on them, to add them to the media plan. Additional information regarding videos potentially of interest can be obtained by selecting, for example by single-clicking on a video from among the grid. The additional information may include the view count per day, the title, a description, a rating, an indication of when the video was first contributed, and a count of the total number of views of the video, and/or other descriptive information.

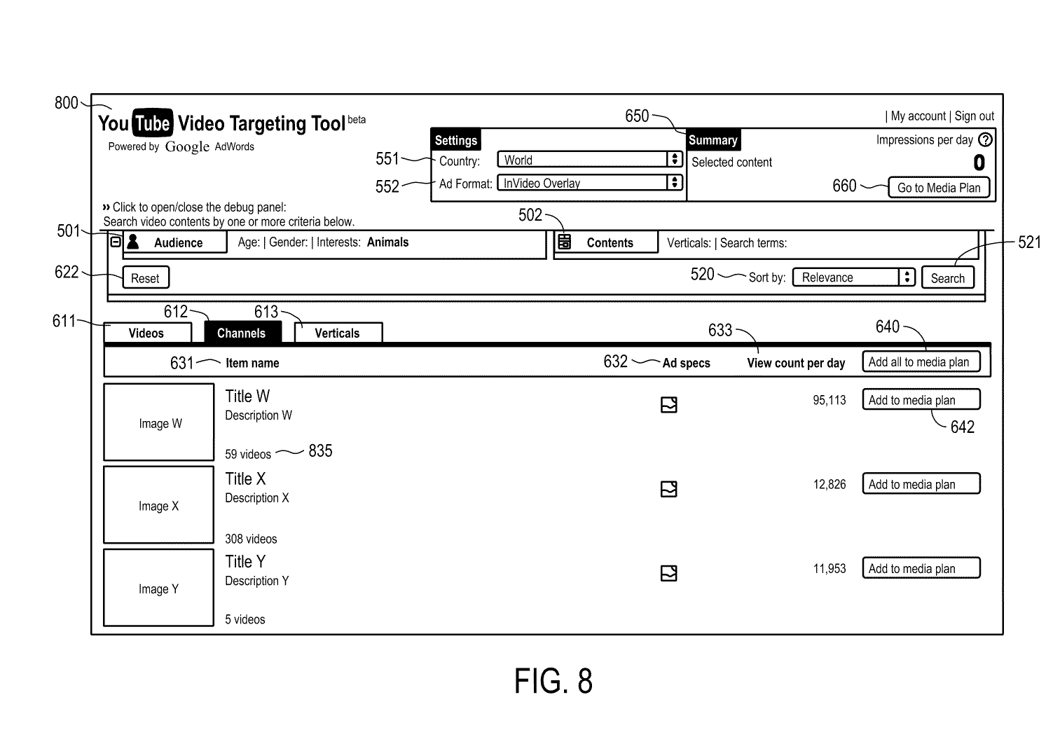

FIG. 8 illustrates another of the advertiser's options for how to view the results from the advertiser's search for videos that meet the audience criteria. The example user interface 800 in FIG. 8 displays the contents of the channels tab 612 as a list of channels including the item name 631, the ad specifications 632, and the view count per day 633. Under the item name 631, the title of the channel can be displayed along with a description of the channel, an image, and the number of videos 835 available for the channel. As described above, in some embodiments, the ad specifications 632 column includes a list of the acceptable ad formats that can be used in connection with the channel's videos, for example, playable video ads, text overlays on portions of the video, etc. The view count per day column 633 includes is the number of times the videos from the channel are played (in whole or in part) per day. By selecting the add to media plan button 642 associated with a channel, the advertiser can add the channel to the media plan. By selecting the add all to media plan button 640, the advertiser can add all the channels in the results to the media plan.

Still another of the advertiser's options for how to view the results from the advertiser's search for videos that meet the audience criteria is to display the contents of verticals tab 613. The listing under the verticals tab 713 also includes the item name 631, the ad specifications 632 and the view count per day 633. Under the item name 631, the name of the vertical can be listed in a hierarchy of categories and sub-categories that can be expanded and collapsed. As described above, in some embodiments, the ad specifications 632 column includes a list of the acceptable ad formats that can be used in connection with the videos within the vertical. The view count per day column 633 includes is the number of times the videos from the vertical are played (in whole or in part) per day. As described above, the advertiser can add or remove verticals from the media plan by selecting buttons under the action column 634. In one alternative embodiment, the advertiser can select to view example videos from within the vertical as a wall of video thumbnails similar to the grid view described above with reference to FIG. 7. In one implementation, the example videos from the vertical are the videos from the vertical having the highest view counts.

Referring back to FIG. 4, optionally, the advertiser viewing the results page may select a video to preview, and the client 130 sends 416 the preview request to the video hosting service 110. Responsive to the preview request, the video hosting service 110 delivers 418 the video identified in the preview request for previewing by the advertiser on the client 130. In one embodiment, the video can be viewed by the advertiser in a pop-up window from the results page. The advertiser can preview selections from or the entire length of the video before or after adding it to the media plan, in order to confirm the contents of the video, the quality of the video, the length of the video, or any other characteristics of the video that the advertiser deems helpful in determining whether to add the video the media plan.

Referring again to FIG. 4, the advertiser then selects one or more videos or groups of videos from the search results for inclusion in a media plan and sends 420 the selections to the video hosting server 110. The media plan module 11054 of the video server system 110 tracks the advertiser's selections and uses them to form a media plan page which is transmitted 422 to the client 130 for display to the advertiser. The contents of the media plan may be displayed in a list including the item name, the ad specifications, and the view counts per day, similar to how the items were listed under the tabs 611, 612, and 613 described above. The advertiser can remove an item from the media plan by selecting an associated remove button. Once the advertiser is satisfied by the contents of the media plan, the advertiser sends 424 an indication that the media plan is complete from the client 130 to the video hosting service 110, in one embodiment, this triggers the media plan module 11054 of the video hosting service 110 to send 426 the media plan contents to the advertising campaign management system 120. In one embodiment, sending the media plan contents to the advertising campaign management system 120 comprises sending the video ID associated with each of the selected videos in the media plan to the advertising campaign management system 120. Accordingly, from the advertising campaign management system 120, the advertiser's ads can be associated with the selected videos or groups of videos listed in the media plan. As a result, when some viewers view videos from among the selected videos and groups of videos, the viewers will also view the advertiser's ads in connection with the videos.

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A method for selecting videos for placing targeted advertisements, each video having a respective audience and wherein the selection is based on demographic characteristics of the respective audience, the method comprising:
storing for each of a plurality of videos in a storage repository, data describing demographic characteristics of viewers of each of the videos;
receiving search criteria from an advertiser, the search criteria specifying at least one demographic characteristic of the respective viewers of a video;
selecting, based on the stored data, a set of videos having demographic characteristic data that matches the search criteria, each video in the set of videos having a respective identifier; and
providing the identifiers of the selected set of videos to the advertiser.

2. The method of claim 1, further comprising:
receiving a request from the advertiser to preview a video; and
providing the requested video for preview by the advertiser.

3. The method of claim 1, further comprising:
receiving, from the advertiser, at least one selection of a video from the set of videos for inclusion in a media plan; and
sending an identifier associated with each advertiser-selected video from the media plan to an advertising campaign management system, whereby each advertiser-selected video is associated with at least one of the advertiser's advertisements.

4. The method of claim 1, wherein the search criteria comprises a country, a gender, an age range, and an interest of the audience.

5. The method of claim 1, wherein the search criteria further comprises a selection from a hierarchy of verticals and at least one keyword.

6. The method of claim 1, wherein the set of videos comprises a plurality of channels.

7. The method of claim 1, wherein providing the identifiers of the selected set of videos to the advertiser further comprises providing an image from each video and an indication of a view count of each video per day.

8. A computer-readable storage medium storing computer program instructions executable by a processor for selecting videos for placing targeted advertisements, each video having a respective audience and wherein the selection is based on demographic characteristics of the respective audience, the computer program instructions comprising instructions for:
storing for each of a plurality of videos in a storage repository, data describing demographic characteristics of viewers of each of the videos;
receiving search criteria from an advertiser, the search criteria specifying at least one demographic characteristic of the respective viewers of a video;
selecting, based on the stored data, a set of videos having demographic characteristic data that matches the search criteria, each video in the set of videos having a respective identifier; and
providing the identifiers of the selected set of videos to the advertiser.

9. The computer-readable storage medium of claim 8, the computer program instructions further comprising instructions for:
receiving a request from the advertiser to preview a video; and
providing the requested video for preview by the advertiser.

10. The computer-readable storage medium of claim 8, the computer program instructions further comprising instructions for:
receiving, from the advertiser, at least one selection of a video from the set of videos for inclusion in a media plan; and
sending an identifier associated with each advertiser-selected video from the media plan to an advertising campaign management system, whereby each advertiser-selected video is associated with at least one of the advertiser's advertisements.

11. The computer-readable storage medium of claim 8, wherein the search criteria comprises a country, a gender, an age range, and an interest of the audience.

12. The computer-readable storage medium of claim 8, wherein the search criteria further comprises a selection from a hierarchy of verticals and at least one keyword.

13. The computer-readable storage medium of claim 8, wherein the set of videos comprises a plurality of channels.

14. The computer-readable storage medium of claim 8, wherein providing the identifiers of the selected set of videos to the advertiser further comprises providing an image from each video and an indication of a view count of each video per day.

15. A video hosting service for selecting videos for placing targeted advertisements, each video having a respective audience and wherein the selection is based on demographic characteristics of the respective audience, the video hosting service comprising:
a storage repository for storing for each of a plurality of videos data describing demographic characteristics of viewers of each of the videos; and
a video targeting tool comprising:
a criteria receipt module for receiving search criteria from an advertiser, the search criteria specifying at least one demographic characteristic of the respective viewers of a video;
a video search engine for selecting, based on the stored data, a set of videos having demographic characteristic data that matches the search criteria, each video in the set of videos having a respective identifier; and
a results page formation module for providing the identifiers of the selected set of videos to the advertiser.

16. The video hosting service of claim 15, further comprising:
a video access server for receiving a request from the advertiser to preview a video and for providing the requested video for preview by the advertiser.

17. The video hosting service of claim 15, wherein the video targeting tool further comprises:
a media plan module for receiving, from the advertiser, at least one selection of a video from the set of videos for inclusion in a media plan and for sending an identifier associated with each advertiser-selected video from the media plan to an advertising campaign management system, whereby each advertiser-selected video is associated with at least one of the advertiser's advertisements.

18. The video hosting service of claim 15, wherein the search criteria comprises a country, a gender, an age range, and an interest of the audience.

19. The video hosting service of claim 15, wherein the search criteria further comprises a selection from a hierarchy of verticals and at least one keyword.

20. The video hosting service of claim 15, wherein the set of videos comprises a plurality of channels.

21. The video hosting service of claim 15, wherein providing the identifiers of the selected set of videos to the advertiser further comprises providing an image from each video and an indication of a view count of each video per day.
